(19) United States
(12) Patent Application Publication
(10) Pub. No.: US 2022/0055145 A1
(43) Pub. Date: Feb. 24, 2022

(54) FRICTION STIR WELDING METHOD

(71) Applicant: MITSUBISHI HEAVY INDUSTRIES ENGINEERING, LTD., Yokohama-shi (JP)

(72) Inventor: Yoshinori KATO, Tokyo (JP)

(21) Appl. No.: 17/509,583

(22) Filed: Oct. 25, 2021

Related U.S. Application Data
(62) Division of application No. 15/506,523, filed on Feb. 24, 2017.

(30) Foreign Application Priority Data
Aug. 28, 2014 (JP) 2014-173990

(51) Int. Cl. B23K 20/12

(52) U.S. Cl. CPC B23K 20/1255; B23K 20/125

(57) ABSTRACT

A friction stir welding method for joining a pair of workpieces by friction stir welding with a friction stir welding tool, includes rotating the friction stir welding tool about an axis in a clockwise direction when a probe is viewed from a lower side of the probe, and contacting first and second faces of the probe of the friction stir welding tool with a portion to be joined of the workpieces with pressing a shoulder face of the friction stir welding tool onto surfaces of the workpieces, while the friction stir welding tool is being rotated. Plastic flow of the workpieces is guided by a spiral groove of the second face so as to be separated from the shoulder face in a direction of the axis.

### CROSS-REFERENCE TO RELATED APPLICATION

This is a divisional application of Ser. No. 15/506,523 filed on Feb. 24, 2017, which is a National Phase of International Application No PCT/JP2015/073994 filed on Aug. 26, 2015, and claims priority of Japanese patent application No. 2014-173990 filed on Aug. 28, 2014, the disclosure of which is incorporated herein by reference.

### TECHNICAL FIELD

The present invention relates to a friction stir welding tool used when a workpiece is joined by friction stir welding and a friction stir welding device including the same.

Priority is claimed on Japanese Patent Application No. 2014-173990, filed Aug. 28, 2014, the content of which is incorporated herein by reference.

### BACKGROUND ART

As one of methods of joining a workpiece made of two members, friction stir joining is known.

Friction stir joining is a joining method in which a workpiece is joined using frictional heat generated at a surface of the workpiece by rotating a tool in a state in which a joined portion of the workpiece is pressed against a shoulder surface of the tool.

Here, in friction stir welding, a plastic flow occurs when a workpiece is stirred by a tool at a time of joining. Furthermore, in order to perform joining while occurrence of joining defects or the like is reduced, it is necessary that the material of the plastically flowing workpiece is caused to actively flow into a joined portion.

Patent Document 1 describes a tool in which a coating layer is provided in a probe in which stability of joining and adhesion resistance of a workpiece with respect to the tool needs to be improved. Furthermore, Patent Document 1 describes that, in order to improve adhesion resistance in the tool, a numerical value in which a surface roughness Ra of the coating layer does not exceed 0.6 μm is preferable.

### CITATION LIST

### Patent Literature

### Patent Document 1

PCT International Publication No. WO2013/129320

### SUMMARY OF INVENTION

### Technical Problem

As described above, the numerical value of the surface roughness Ra of the coating layer disclosed in Patent Document 1 is preferably a numerical value which does not exceed 0.6 μm. In other words, the numerical value of the surface roughness Ra is preferably a relatively small numerical value. In the tool disclosed in Patent Document 1, a surface roughness Ra value of the coating layer is small. Thus, sufficient frictional heat due to rotation of the tool does not occur, and thus a sufficient amount of plastic flow cannot be expected.

Particularly, a circumferential speed of the tool with respect to the workpiece is 0 at a position of a distal end of the probe, and thus the workpiece is not easily stirred. Thus, it is necessary to cause the plastically flowing workpiece to actively flow into the distal end of the probe.

The present invention is for the purpose of providing a friction stir welding tool in which a workpiece is caused to sufficiently plastically flow and the workpiece can be joined satisfactorily, a friction stir welding device using the friction stir welding tool, and a friction stir welding method.

### Solution to Problem

A friction stir welding tool according to a first aspect of the present invention includes: a first face which is rotated about an axis relative to a joined portion in a state in which the first face comes into contact with the joined portion of a workpiece and in which an arithmetic mean roughness Ra value is greater than or equal to 0.8 μm and less than or equal to 25 μm; and a second face which is formed continuously with the first face, which is rotated about the axis relative to the joined portion in a state in which the second face comes into contact with the joined portion, and in which an arithmetic mean roughness Ra value is smaller than that of the first face.

With such a friction stir welding tool, if the tool rotates about the axis, frictional heat is increased due to the relatively coarse first face of which the arithmetic mean roughness Ra is greater than or equal to 0.8 μm and less than or equal to 25 μm. As a result, the amount of stirring of the workpiece is increased, and thus a plastic flow is promoted. Furthermore, a material of the workpiece stirred by the first face is allowed to flow into the joined portion while adhesion of the plastically flowing workpiece is minimized by the second face smoother than the first face.

In the friction stir welding tool according to a second aspect of the present invention, the arithmetic mean roughness Ra value of the first face in the first aspect may be greater than or equal to 1.6 μm and less than or equal to 25 μm.

The arithmetic mean roughness Ra of the first face is set to such a numerical value so that frictional heat can be further increased and the amount of stirring of the workpiece can be increased. As a result, the plastic flow of the workpiece using the first face can be promoted.

In the friction stir welding tool according to a third aspect of the present invention, the arithmetic mean roughness Ra value of the first face in the first aspect may be greater than or equal to 3.2 μm and less than or equal to 25 μm.

The arithmetic mean roughness Ra of the first face is set to such a numerical value so that frictional heat can be further increased and the amount of stirring of the workpiece can be increased. As a result, the plastic flow of the workpiece using the first face can be promoted.

In the friction stir welding tool according to a fourth aspect of the present invention, in addition to a constitution of the friction stir welding tool in any one of the first to third aspects, the friction stir welding tool further includes: a probe inserted into the joined portion of the workpiece at a time of joining, having a columnar shape formed about an axis, and rotating about the axis; and a shoulder with a columnar shape formed about the axis, rotated together with the probe, and having a shoulder surface pressed against a surface of the workpiece at the time of joining, wherein the first face and the second face may be formed in an outer circumferential surface of the probe to be adjacent to each other in the circumferential direction.

The workpiece stirred by the first face due to rotation of the probe moves by spreading on the outer circumferential surface of the probe in the circumferential direction so that a plastic flow is promoted. For this reason, stirred workpiece can further flow into the joined portion. Thus, satisfactory joining can be performed.

In the friction stir welding tool according to a fifth aspect of the present invention, spiral grooves with a spiral shape extending to one direction along the axis as going toward the circumferential direction of the probe may be formed in the second face in the fourth aspect.

A plastic flow of the workpiece from the first face is guided through the spiral grooves of the second face. Furthermore, the direction of rotation of the tool is appropriately selected so that the plastically flowing workpiece can be guided to the distal end of the probe. Therefore, stirred workpieces are further allowed to flow into the joined portion. Thus, satisfactory joining can be further performed.

In the friction stir welding tool according to a sixth aspect of the present invention, in addition to a constitution of the friction stir welding tool in any one of the first to third aspects, the friction stir welding tool further includes: a probe inserted into the joined portion of the workpiece at a time of joining, having a columnar shape formed about an axis, and rotating about the axis; and a shoulder with a columnar shape formed about the axis, rotated together with the probe, and having a shoulder surface pressed against a surface of the workpiece at the time of joining, wherein the first face and the second face may be formed in the shoulder surface to be adjacent to each other in the circumferential direction.

The workpiece stirred by the first face due to rotation of the shoulder moves to be widened on the shoulder surface in the circumferential direction so that a plastic flow is promoted. For this reason, stirred workpieces are further allowed to flow into the joined portion. Thus, satisfactory joining can be performed.

In the friction stir welding tool according to a seventh aspect of the present invention, a spiral groove with a spiral shape may be formed extending outwards in a radial direction of the axis as going forward in a direction of rotation of the shoulder in the circumferential direction in the shoulder surface in the sixth aspect, the first face may be a surface of the shoulder surface other than a position at which the spiral groove is formed, and the second face may be an inner surface of the spiral groove.

As described above, the plastic flow of the workpiece from the first face is guided through the spiral groove of the smoother second face. Furthermore, the workpiece is guided to the probe side along with rotation of the shoulder surface. Therefore, stirred workpieces are further allowed to flow into the joined portion. Thus, satisfactory joining can be further performed.

A friction stir welding device according to an eighth aspect of the present invention includes: the friction stir welding tool according to any one of the first to seventh aspects; and a device main body configured to hold the friction stir welding tool and to rotate the friction stir welding tool relative to the workpiece.

With such a friction stir welding device, if the friction stir welding tool rotates about the axis, frictional heat is increased by the relatively coarse first face. Furthermore, an amount of stirring of the workpiece is increased, and thus a plastic flow of the workpiece is promoted. The workpiece stirred by the first face is allowed to flow into the joined portion while adhesion of the plastically flowing workpiece is minimized using a second face smoother than the first face.

A friction stir welding method according to a ninth aspect of the present invention includes: a tool contact step of bringing a first face of a friction stir welding tool of which an arithmetic mean roughness Ra value is greater than or equal to 0.8 μm and less than or equal to 25 μm into contact with a joined portion of a workpiece and bringing a second face of the friction stir welding tool, which continues to the first face and of which an arithmetic mean roughness Ra value is smaller than that of the first face, into contact with the joined portion; and a rotating step of rotating the first face and the second face relative to the joined portion.

With such a friction stir welding method, frictional heat is increased by the relatively coarse first face so that an amount of stirring of the workpiece is increased and a plastic flow of the workpiece is promoted. Furthermore, the workpiece stirred by the first face is allowed to flow into the joined portion of the workpiece while adhesion of the plastically flowing workpiece with respect to the friction stir welding tool is reduced using the second face smoother than the first face.

### Advantageous Effects of Invention

According to the friction stir welding tool and the friction stir welding device which have been described above, a workpiece is caused to sufficiently plastically flow and thus the workpiece can be joined satisfactorily.

### BRIEF DESCRIPTION OF DRAWINGS

FIG. 1 is a front view showing a state in which a friction stir welding device according to a first embodiment of the present invention is installed at a workpiece.

FIG. 2 is an enlarged diagram of a probe of a tool of the friction stir welding device according to the first embodiment of the present invention, showing a perspective view when diagonally viewed from a lower side.

FIG. 3 is a graph showing a relationship between an arithmetic mean roughness Ra of a first face formed in the probe of the tool of the friction stir welding device and a stirring property of a workpiece according to the first embodiment of the present invention.

FIG. 4 is a flowchart for describing steps of a friction stir welding method using the tool of the friction stir welding device according to the first embodiment of the present invention.

FIG. 5 is a front view showing a state in which a friction stir welding device according to a second embodiment of the present invention is installed at a workpiece.

FIG. 6 is a view showing an upper shoulder surface of a tool of the friction stir welding device according to the second embodiment of the present invention, showing a cross-sectional view taken along line A-A of FIG. 5.

FIG. 7 is a view showing a lower shoulder surface of the tool of the friction stir welding device according to the second embodiment of the present invention, showing a cross-sectional view taken along line B-B of FIG. 5.

### DESCRIPTION OF EMBODIMENTS

### First Embodiment

Hereinafter, a friction stir welding device 1 according to a first embodiment of the present invention will be described.

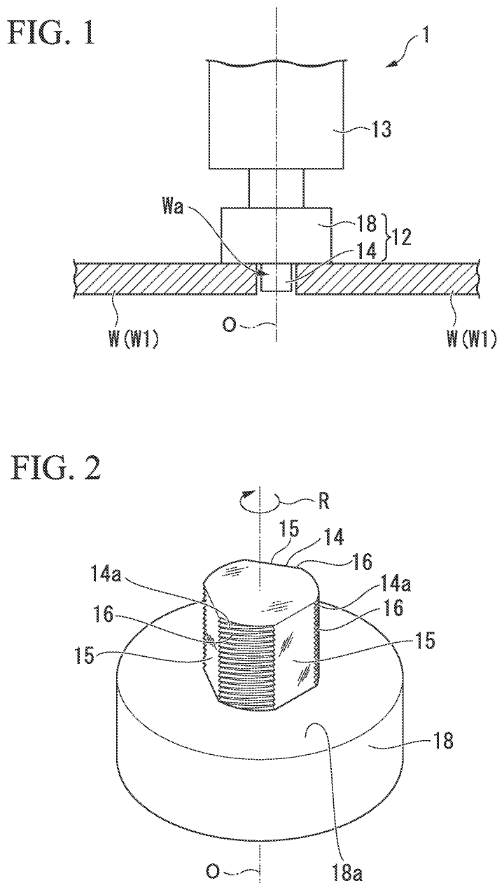

As shown in FIG. 1, for example, the friction stir welding device 1 is installed at a joined portion Wa serving as an abutting portion in a workpiece W obtained when two plates (or hollow materials or the like) W1 abut against each other, and the workpiece W is joined by friction stir welding.

The friction stir welding device 1 includes a friction stir welding tool 12 (hereinafter simply referred to as a “tool 12”) pressed against the joined portion Wa and a device main body 13 configured to hold the tool 12 and to rotate the tool 12 relative to the workpiece W in a state in which the tool 12 is pressed against the workpiece W.

In this embodiment, the device main body 13 and the tool 12 are installed at the workpiece W from above the workpiece W at a time of joining.

The tool 12 includes a probe 14 inserted into the joined portion Wa of the workpiece W at the time of joining and a shoulder 18 configured to support the probe 14.

The probe 14 has a cylindrical shape formed about an axis O and is rotated about the axis O by a power source (not shown) provided in the device main body 13.

Also, spiral grooves 14a with a spiral shape over the entire region in an axis O direction are formed in an outer circumferential surface of the probe 14. The spiral grooves 14a are formed extending toward one direction along the axis O (an upper side) as going toward a circumferential direction (forward in a direction of rotation R of the tool 12). In other words, the spiral grooves 14a are formed in a right-handed screw shape, and the direction of rotation R of the tool 12 is a clockwise direction when the tool 12 is viewed from a lower side of the probe 14.

First faces 15 are formed in the probe 14 by cutting a portion of the outer circumferential surface, in which the spiral grooves 14a are formed, at a plurality of places away from each other in the circumferential direction (three places in this embodiment) along the axis O over the entire region in the axis O direction. The first faces 15 have a planar shape along the axis O. The first faces 15 are formed at regular intervals in the circumferential direction in this embodiment.

An arithmetic mean roughness Ra value of the first faces 15 is greater than or equal to 0.8 μm and less than or equal to 25 μm.

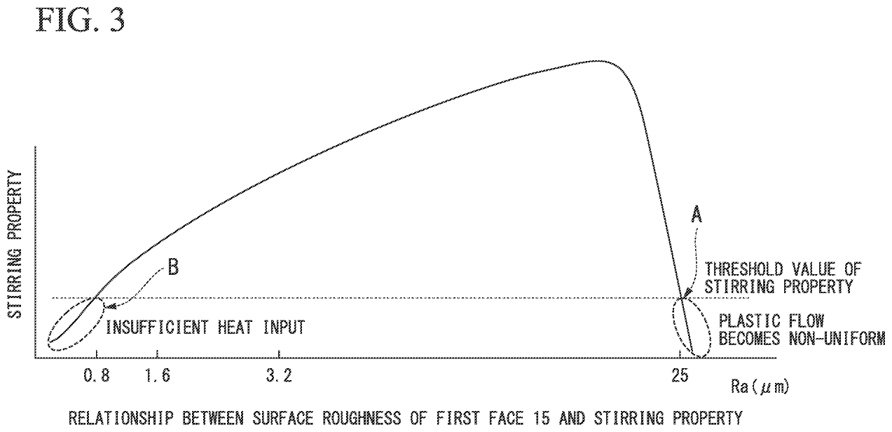

When an arithmetic mean roughness Ra is larger than 25 μm in the case of Ra as shown in a portion A of FIG. 3, an upper limit of the arithmetic mean roughness Ra is 25 μm because a plastic flow becomes non-uniform. In other words, an upper limit value of Ra in this embodiment is determined so that the stirred workpiece W flows to the joined portion Wa by causing a plastic flow direction not to be non-uniform. When Ra is smaller than 0.8 μm as shown in a portion B of FIG. 3, a lower limit of Ra is 0.8 μm because the amount of heat input from the tool 12 to the workpiece W is insufficient and thus it is difficult for sufficient plastic flow to occur.

Here, the arithmetic mean roughness Ra value is preferably greater than or equal to 1.6 μand less than or equal to 25 μ, and the arithmetic mean roughness Ra value is preferably greater than or equal to 3.2 μand less than or equal to 25 μ.

As described above, the probe 14 includes, on the outer circumferential surface thereof, the first faces 15 and a plurality of (three in this embodiment) second faces 16 which are adjacent to the first faces 15 in the circumferential direction, which are separated from each other at regular intervals in the circumferential direction, and in which the spiral grooves 14a are formed. The arithmetic mean roughness Ra value of the second faces 16 is smaller than that of the first faces 15. Thus, the second faces 16 are smoother than the first faces 15.

The first faces 15 and the second faces 16 may not be formed at regular intervals in the circumferential direction. Furthermore, the number of first faces 15 and the number of second faces 16 may be any number, but are preferably odd numbers.

The shoulder 18 has a cylindrical shape formed about the axis O coaxially with the probe 14. Furthermore, the shoulder 18 is disposed to face one surface (an upper surface) of the workpiece W and supports the probe 14. The shoulder 18 rotates about the axis O together with the probe 14. The shoulder 18 has a shoulder surface 18a pressed against the surface of the workpiece W at the time of joining.

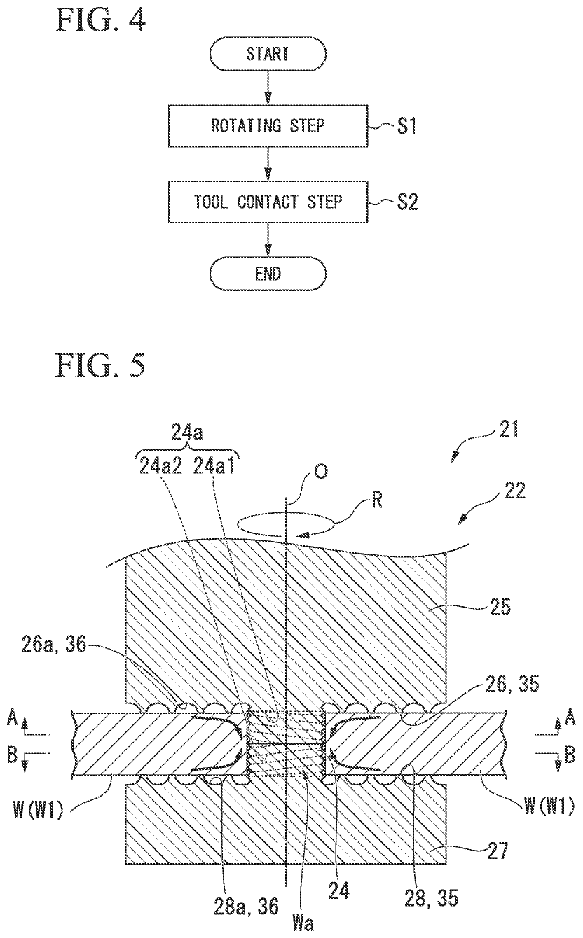

At the time of joining, first, the tool 12 rotates about the axis O (refer to a rotating step S1: FIG. 4), and then the first faces 15 and the second faces 16 are brought into contact with the joined portion Wa of the workpiece W (refer to a tool contact step S2: FIG. 4) while the workpiece W is pressed by the shoulder surface 18a so that such a friction stir welding tool 12 can increase frictional heat using the relatively coarse first faces 15 of which the arithmetic mean roughness Ra is greater than or equal to 0.8 μm and less than or equal to 25 μ. As a result, the workpiece W stirred by the first faces 15 moves to be widened on the outer circumferential surface of the probe 14 in the circumferential direction so that the plastic flow of the workpiece W is promoted. For this reason, more stirred workpieces W are allowed to flow into the joined portion Wa, and thus satisfactory joining can be performed.

Also, a material of the workpiece W stirred by the first faces 15 is allowed to flow into the joined portion Wa while adhesion of the workpiece W plastically flowing using the second faces 16 smoother than the first faces 15 is reduced.

The spiral grooves 14a are formed in the second faces 16. For this reason, the plastic flow of the workpiece W from the first faces 15 is guided through the spiral grooves 14a of the second faces 16 along with the rotation of the tool 12 and is guided to a distal end side of the probe 14. Therefore, more stirred workpieces W are allowed to flow into the joined portion Wa, and thus the workpiece W can be joined satisfactorily.

When the arithmetic mean roughness Ra value of the first faces 15 is greater than or equal to 1.6 μand less than or equal to 25 μand preferably greater than or equal to 3.2 μand less than or equal to 25 μ, frictional heat is further increased by the first faces 15 and thus an amount of stirring of the workpiece W can be further increased. Thus, the plastic flow of the workpiece W using the first faces 15 can be further promoted, the amount of plastic flow of the workpiece W to the joined portion Wa is increased, and thus the workpiece W can be joined satisfactorily.

Also, the arithmetic mean roughness Ra value of the first faces 15 is greater than or equal to 0.8 μm and less than or equal to 25 μ. Thus, a surface of the probe 14 is relatively coarse. Therefore, precise machining in which the first faces 15 are smoothened is not needed. As a result, costs can be reduced.

Here, in this embodiment, the spiral grooves 14a are not necessarily formed in the second faces 16.

### Second Embodiment

Hereinafter, a friction stir welding device 21 of a second embodiment of the present invention will be described with reference to FIG. 5.

Constituent elements which are the same as those of the first embodiment are denoted with the same reference numerals, and detailed descriptions thereof will be omitted.

This embodiment and the first embodiment differ in view of a tool 22.

In other words, in this embodiment, the tool 22 includes a probe 24 inserted into a joined portion Wa of a workpiece W at a time of joining, an upper shoulder 25 configured to support the probe 24 from above, and a lower shoulder 27 configured to support the probe 24 from below.

The probe 24 has a cylindrical shape formed about an axis O. The probe 24 is rotated about the axis O by a power source (not shown) provided in a device main body 13.

A probe groove 24a with a spiral shape over the entire region in an axis O direction is formed in an outer circumferential surface of the probe 24. As the probe groove 24a, a first groove 24a1 formed at the upper shoulder 25 side in the probe 24 and a second groove 24a2 formed at the lower shoulder 27 side in the probe 24 are formed using a central position of the probe 24 in the axis O direction as a boundary.

The first groove 24a1 is formed extending toward one side of the axis O (an upper side) as going toward one side in a circumferential direction (a front of a direction of rotation R of the tool 22). In other words, the first groove 24a1 is formed in a left screw shape. Furthermore, the direction of rotation R of the tool 22 is a counterclockwise direction when the tool 22 is viewed from a lower side of the probe 24.

The second groove 24a2 is formed extending toward the other direction along the axis O (a lower side) as going toward the circumferential direction (the front of the direction of rotation R of the tool 22). In other words, the second groove 24a2 is formed in a right screw shape.

As described above, the left-screw-shaped groove and the right-screw-shaped groove are formed in the outer circumferential surface of the probe 24 using the central position of the probe 24 in the axis O direction as the boundary.

The upper shoulder 25 has a cylindrical shape formed about the axis O coaxially with the probe 24. The upper shoulder 25 is disposed to face an upper surface serving as one surface of the workpiece W. Furthermore, the upper shoulder 25 supports the probe 24 and rotates together with the probe 24. The upper shoulder 25 has an upper shoulder surface 26 pressed against the upper surface of the workpiece W at the time of joining.

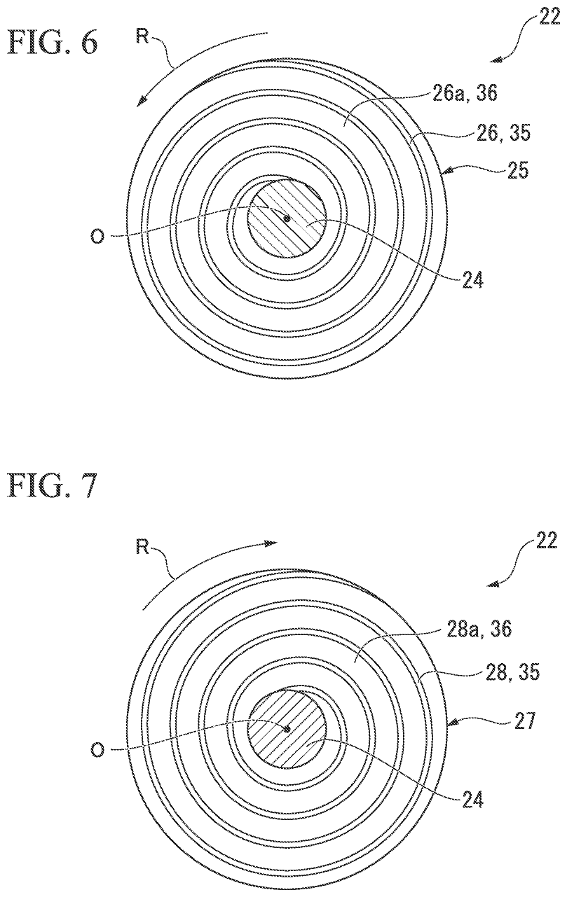

As shown in FIG. 6, a first spiral-shaped groove 26a with a spiral shape is formed extending outward in a radial direction of the axis O as going toward the front of the direction of rotation R of the tool 22 in the circumferential direction in the upper shoulder surface 26. In other words, the first spiral-shaped groove 26a is formed in a helical shape when viewed from below.

The first spiral-shaped groove 26a is open in the outer circumferential surface, that is, an outer-circumferential-side edge, of the upper shoulder 25 at a position of an outside in the radial direction of the upper shoulder surface 26, and continues to the outer circumferential surface of the probe 24 at a position of an inside in the radial direction thereof.

The lower shoulder 27 has a cylindrical shape formed about the axis O coaxially with the probe 24. The lower shoulder 27 is disposed to face a lower surface serving as the other surface of the workpiece W. Furthermore, the lower shoulder 27 supports the probe 24 and rotates together with the probe 24. The lower shoulder 27 has a lower shoulder surface 28 pressed against a lower surface of the workpiece W at the time of joining.

As shown in FIG. 7, a second spiral-shaped groove 28a with a spiral shape outward in a Radial direction of the axis O is formed in the lower shoulder surface 28 toward the front of the direction of rotation R of the tool 22 in the circumferential direction. In other words, the second spiral-shaped groove 28a is formed in a helical shape when viewed from above.

The second spiral-shaped groove 28a is open in the outer circumferential surface, that is, an outer-circumferential-side edge, of the lower shoulder 27 at a position of an outside in the radial direction of the lower shoulder surface 28, and continues to the outer circumferential surface of the probe 24 at a position of an inside in the radial direction thereof.

Surfaces of other portions (hereinafter referred to as “mountain portions”) of the upper shoulder surface 26 and the lower shoulder surface 28, in which the first spiral-shaped groove 26a and the second spiral-shaped groove 28a in the upper shoulder surface 26 and the lower shoulder surface 28 are not formed, are first faces 35 which are the same as the first faces 15 of the first embodiment. In other words, an arithmetic mean roughness Ra value at surfaces of the mountain portions is greater than or equal to 0.8 μm and less than or equal to 25 μm, is preferably greater than or equal to 1.6 μm and less than or equal to 25 μm, and is more preferably greater than or equal to 3.2 μm and less than or equal to 25 μm.

Inner surfaces of the first spiral-shaped groove 26a and the second spiral-shaped groove 28a are second faces 36 which are the same as the second faces 16 of the first embodiment.

According to the friction stir welding device 21 in this embodiment, when the friction stir welding tool 22 rotates about the axis O, frictional heat can be increased by the relatively coarse first faces 35 in the upper shoulder surface 26 and the lower shoulder surface 28. Thus, the amount of stirring of the workpiece W is increased, and thus the plastic flow of the workpiece W is promoted.

The workpiece W is guided using the first spiral-shaped groove 26a and the second spiral-shaped groove 28a serving as the second faces 36 of which the inner surfaces are smoother than the first faces 35. For this reason, a material of the workpiece W plastically flows toward the inside in the radial direction of the probe 24 side along with the rotation of the upper shoulder surface 26 and the lower shoulder surface 28. Therefore, stirred workpieces W are further allowed to flow into the joined portion Wa, and thus the workpiece W can be joined satisfactorily.

The first groove 24a1 and the second groove 24a2 having screw shapes with different directions are formed in the probe 24 as the probe groove 24a. For this reason, the plastically flowing workpiece W guided by the first spiral-shaped groove 26a and the second spiral-shaped groove 28a is fed into the joined portion Wa along the rotation of the tool 22 (refer to arrows of FIG. 5). Therefore, satisfactory joining can be performed while occurrence of joining defects inside the joined portion Wa is reduced.

Here, although a bobbin tool including the probe 24, the upper shoulder 25, and the lower shoulder 27 is used as the tool 22 in this embodiment, the present invention can also be applied to, for example, a case in which a tool like the tool 12 of the first embodiment having the upper shoulder 25 (or the lower shoulder 27) and the probe 14 is used.

Although the embodiments of the present invention have been described in detail above, some changes in design are also possible without departing from the technical idea of the present invention.

For example, a groove which is the same as the first spiral-shaped groove 26a of the tool 22 in the second embodiment may be formed in the tool 12 in the first embodiment.

For example, although a case in which two plates W1 which abut against each other, as the workpiece W are joined has been described in the above-described embodiments, two plates W1, which are overlapped with each other, as the workpiece W can also be joined using the tool 12 or 22 in the above-described embodiments.

### INDUSTRIAL APPLICABILITY

According to the friction stir welding tool, the friction stir welding device using the friction stir welding tool, and the friction stir welding method which have been described above, a workpiece is caused to sufficiently plastically flow and thus the workpiece can be joined satisfactorily.

### REFERENCE SIGNS LIST

1 Friction stir welding device

12 Tool (for friction stir welding)

13 Device main body

14 Probe

14a Spiral groove

15 First face

16 Second face

18 Shoulder

18a Shoulder surface

21 Friction stir welding device

22 Tool (for friction welding)

24 Probe

24a Probe groove

24a1 First groove

24a2 Second groove

25 Upper shoulder

26 Upper shoulder surface

26a First spiral-shaped groove

27 Lower shoulder

28 Lower shoulder surface

28a Second spiral-shaped groove

35 First face

36 Second face

W Workpiece

Wa Joined portion

W1 Plate

O Axis

R Direction of rotation

S1 Rotating step

S2 Tool contact step

What is claimed is:

1. A friction stir welding method for joining a pair of workpieces by friction stir welding with a friction stir welding tool, the friction stir welding tool including:
a probe having a columnar shape formed about an axis, and which is provided with first and second faces formed on an outer circumferential surface of the probe adjacent to each other in a circumferential direction of the probe, wherein the first face has a planar shape along the axis, and the second face has a spiral groove with a right-handed screw shape formed on the second face; and
a shoulder supporting the probe, on which a shoulder face is formed, and which is rotatable together with the probe about the axis, the method comprising:
rotating the friction stir welding tool about the axis in a clockwise direction when the probe is viewed from a lower side of the probe; and
contacting the first and second faces of the probe of the friction stir welding tool with a portion to be joined of the workpieces with pressing the shoulder face of the friction stir welding tool onto surfaces of the workpieces, while the friction stir welding tool is being rotated, wherein plastic flow of the workpieces is guided by the spiral groove of the second face so as to be separated from the shoulder face in a direction of the axis.

2. The friction stir welding method according to claim 1, wherein
a first arithmetic mean roughness Ra value of the first face is greater than or equal to 0.8 μm and less than or equal to 25 μ, and
a second arithmetic mean roughness Ra value of a surface of the spiral groove of the second face is smaller than the first arithmetic mean roughness Ra value of the first face.

3. The friction stir welding method according to claim 2, wherein the first arithmetic mean roughness Ra value of the first face is greater than or equal to 1.6 μand less than or equal to 25 μ.

4. The friction stir welding method according to claim 2, wherein the first arithmetic mean roughness Ra value of the first face is greater than or equal to 3.2 μand less than or equal to 25 μ.
